(19) United States
(12) Patent Application Publication
(10) Pub. No.: US 2021/0047095 A1
(43) Pub. Date: Feb. 18, 2021

(54) ASEPTIC PROTECTIVE SYSTEM AGAINST GERMS AND DIRT FOR BEVERAGE BOTTLES AND CANS AND SYSTEM FOR JOINING BEVERAGE CANS

(71) Applicant: MANUEL MUNOZ SAIZ, ALMERIA (ES)

(72) Inventors: MANUEL MUNOZ SAIZ, ALMERIA (ES); JESUS HERNANDEZ FEBLES, SANTA CRUZ DE TENERIFE (ES)

(21) Appl. No.: 16/991,627

(22) Filed: Aug. 12, 2020

(30) Foreign Application Priority Data
Aug. 13, 2019 (ES) U201900396
Nov. 14, 2019 (ES) U201900571

(51) Int. Cl. B65D 53/08; B65D 21/02; B65D 17/28

(52) U.S. Cl. CPC B65D 53/08; B65D 55/0818; B65D 17/4012; B65D 21/0227

(57) ABSTRACT

The aseptic protective system against germs and dirt for beverage bottles and cans and system for joining beverage cans, consists of applying a protective cover to the end or mouth of the bottles or cans of drinks, whose protective elements are sheets or films, sleeves, caps, lids, stoppers or belts made of biodegradable plastic materials, which protect them from contamination by germs and dirt. attaching or tongue-and-groove joints to groups or rows of cans, the attachments use covers, sheets of tape, bands or a cover of biodegradable material. The groups or rows of cans are constructed in a way that the bottoms of the cans are placed at their ends towards the outside and therefore those carrying the nozzles and opener are protected internally from dirt and contamination. The union is done by tongue and groove, attached or glued, and adding covers or sleeves, tapes or bands of metal sheets.

### INDEX TO RELATED APPLICATIONS

This application claims the benefit of Spanish application No. U201900396 filed Aug. 13, 2019 and Spanish application No. U201900571 filed Nov. 14, 2019, the disclosures of which are incorporated herein by reference in their entirety.

### Field of Invention

In the manufacture, filling, storage, transport and dispensing of beverage cans and bottles.

### State of the Art

The cans and bottles of soft drinks, beer, etc. must be consumed after opening. Non-biodegradable plastics are used for storage and transport. Both land and sea have been filled with polluting plastics, which will be difficult to remove, especially if a policy of using biocompatible plastics is not started already, where possible. In addition, with this system the cans are grouped together, especially with smaller ones, and protected to avoid contamination from dirt, fungi and microorganisms.

### DESCRIPTION OF THE INVENTION

### Objective of the Invention and Advantages

To obtain a coupling between attached or tongue and groove beverage cans in a simple and economic way and especially with smaller cans. Using several joining and storage systems.

Eliminating or reducing the use of non-biodegradable plastic or thermoplastic material, favouring the environment.

Protect the ends, mouths or necks of the bottles, cans or beverage cans from dirt, bacteria, fungi or microorganisms.

Use biodegradable plastic films, bands, sleeves, caps, covers or stoppers as protective elements.

This system could be of obligatory use, if there is not something better.

### Problem to be Solved

The area where the lips are applied to bottles or cans for the consumption of drinks, soft drinks, water, etc., as it is not protected, is usually exposed during storage and transport to all kinds of germs and dirt. This occurs especially in the last stage of distribution, so protection must be provided at the place of manufacture to prevent contamination from reaching the consumer. Because of the large number of cans used and the waste produced, especially the plastics used to transport them, it is very important to take action to avoid the use of non-biodegradable plastics and other polluting waste materials. This is especially important when they are consumed in areas without garbage collection, such as at sea or in the countryside.

The aseptic protective system against germs and dirt for beverage bottles and cans and system for joining beverage cans of the invention, consists of applying a protective cover to the end or mouth of the bottles or cans of drinks and soft drinks including water, whose protective elements consist of sheets or films, sleeves, caps, lids, stoppers or belts made of biodegradable plastic materials, which protect them from contamination by germs and dirt. attaching or tongue-and-groove joints to groups or rows of cans, the attachments use covers, sheets of tape, bands or a cover of biodegradable material or plastic that is added to them.

The caps or stoppers can be fitted under pressure, but they generally have strips or bands that tear, separate and leave the ends of the bottle or can spouts free. Sleeves can also be used whose peripheral edge adheres to the bottle or can thermally, melting it by applying heat.

The caps or lids can be fixed with a light layer of adhesive, or with fixing and breaking points. These caps or lids can have skirts, optionally adhesive, to extend the protection area.

The cover can be applied to pairs of cans with a tongue-and-groove joint, covering their joint with the protective strip or band with the strip or band of breakage or tearing, which can be replaced by a tear or weakening line.

Using biodegradable materials such as biodegradable plastics especially based on starch, corn-starch and other vegetables that avoid the use of cellulose from trees, for grouping, cleaning and protection. Cellophane, which is a natural polymer, can also be used, but it is obtained from cellulose. In other cases, a cover of aluminium foil, tin or metallized biodegradable plastic can be used.

There are currently bottles that have a foil cover around the neck, which, although they meet the requirements for protection from dirt and germs, are not valid because they do not separate or remove easily.

The covers proposed are generally attached, but preferably they can be loose except on the periphery of the bottle in contact with the container or can. In such periphery it can have more pressure on the container.

The protective elements are loose except in the periphery of the same in contact with the container, in this periphery carries a higher pressure on the container. The protective elements may be attached to the containers.

The groups or rows of cans are constructed in such a way that the bottoms of the cans are placed at their ends towards the outside and therefore those carrying the nozzles and opener are protected internally from dirt and contamination.

The union can be done by tongue and groove, attached or glued, and by adding some covers or sleeves, tapes or bands of metal sheets, biodegradable materials such as biodegradable plastics especially based on corn-starch and other plants that avoid the use of cellulose from the trees, for grouping, cleaning and protection.

Instead of the rings of subjection, trays are used which carry lodgings for the tongue and groove of the ends of the cans, allowing besides to hold, to attach the cans by their ends where they carry the nozzle, so that these are protected of polluting elements. The butts of the cans must be placed at both ends of each group of cans. To do this, the last can is inverted at one end. This way all the nozzles are protected from contamination.

The ends of the cans can be cylindrical or conical.

In principle, the wrapping system of covers, tapes or bands of metal sheets or biodegradable material or plastic can be used with the standardized cans, and in a second term, other systems that use the modified cans and tongue and groove can be used.

The attachment or tongue-and-groove joint is made lengthwise, as follows:

(a) By means of bands or sheets of tape around the ends of both cans. These are valid for all systems.

b) By adding between the ends of each two cans an independent supplemental band or ring, which carries the system of tabs and cavities mentioned in system a), which is tongue-and-groove with both ends of the cans next to each other.

c) By means of bands or sheets that surround the ends of both cans attached to each other (a portion of the central area of the bands is removed and detached to leave the cans free).

d) By means of strips that surround the ends of both cans. These are removed for use.

e) By means of a protective sleeve that completely surrounds each group or row of cans attached to each other.

(f) By means of a radial flexible flange, curved or semi-circular in shape, on the perimeter of the end of one of the cans which is inserted or covered in the end of the adjacent canister which has a recess or semi-cylindrical cavity for housing and fixing the flexible flange. The flexible flange can be slotted for easy bending.

In cases b) and f) where tapes, bands or covers are not used, these can be added for greater protection and fastening.

### BRIEF DESCRIPTION OF THE DRAWINGS

FIG. 1 shows a schematic and partial view of two cans or tins attached lengthwise and covered and protected at their adjoining ends with a protective and advertising strip of biodegradable plastic material.

FIGS. 2 to 5 show schematic views of groups of cans or tins covered totally or partially with a biodegradable plastic film, which holds them in place and simultaneously prevents contamination with dirt and germs of all kinds. The ends that carry the nozzle are the tongue and groove and those that have the protection cover, leaving the base that does not need protection at the ends.

FIGS. 6 to 8 show schematic, partially sectioned and partial views of pairs of cans or JARJARs which are tongue and groove, lengthwise to each other. Both the material of the cavities and the tabs have a great degree of flexibility, however to make this characteristic more ostensible they are exaggerated in the drawings, in reality they would be almost imperceptible.

FIG. 9 shows a set of groups of cans packed and prepared for storage or transport ¬ Their outermost ends are also the bases of the cans.

FIG. 10 shows a perspective and schematic view of a box of biodegradable material, made of biodegradable plastic foam, which allows it to be transported and stored without the use of contaminants.

FIG. 11 shows a schematic view of a pressurised tongue and groove box which, once fitted, has a band added around it to increase its protection.

FIG. 12 shows a schematic and partial view of cans or tins attached lengthwise and covered and protected at their ends with a biodegradable plastic band and whose interior carries the annular channels for tongue and groove. These are best shown in FIGS. 6, 7 and 8.

FIG. 13 shows a schematic, elevated view of a bottle with the germ and dirt protection system of the invention.

FIGS. 14 to 16 show schematic and top view of bottles with variants of the protection system of the invention.

FIGS. 17 to 21 show schematic and elevation views of cans with the system of the invention.

FIG. 22 shows a schematic and elevation view of a pair of tongue and groove cans with the covered joint with the protection system of the invention.

### MORE DETAILED DESCRIPTION OF A OF REALIZATION MODE

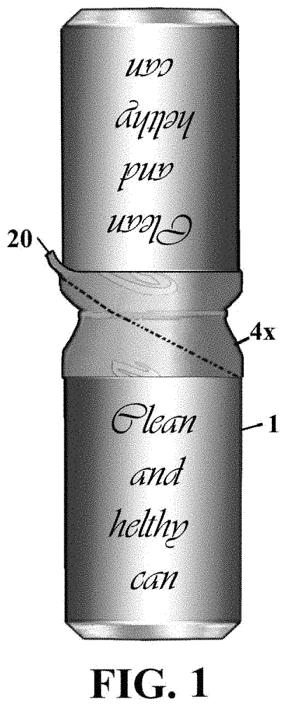

FIG. 1 shows a form of realization of the invention, it shows two cans (1) whose adjoining ends are covered with a tape or protective band of biodegradable plastic (4x) which is removed by pulling and tearing with the tab (20). It carries the ends that carry the nozzles inwards and the bases of the cans outwards

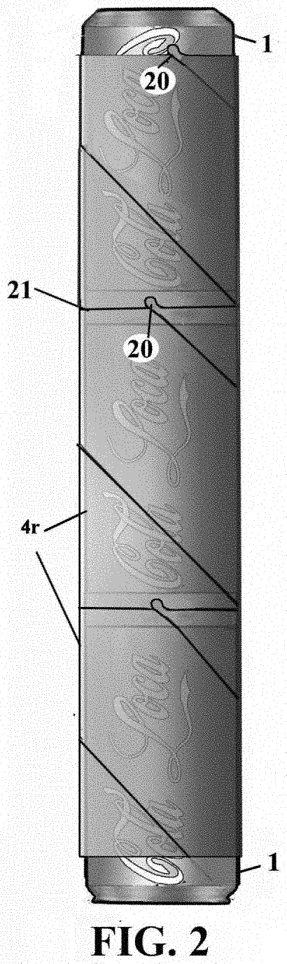

FIG. 2 shows a group or row of cans (1) whose adjoining ends are covered with a sheet, sealed and protective cover of biodegradable plastic (4r), which is removed in sections by pulling and tearing with the tabs (20), which tear up to the joint of each two cans (21), leaving both free. The sheet or cover must cover both ends, it is not shown in this way to see in more detail the way it is wrapped and its use. The bases of the cans are at the ends of each group or row. The film can be transparent or advertising.

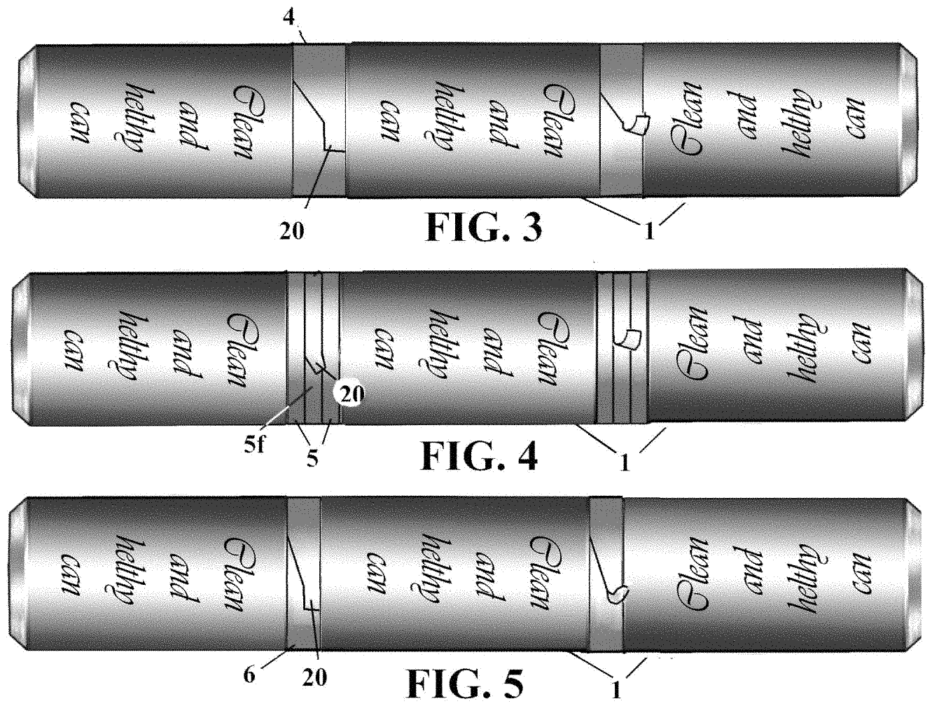

FIG. 3 shows the cans (1) covered at their ends with the strip or sheet (4) attached, which is removed by pulling and tearing the tab (20). The bases of the cans remain at the ends of each group or set.

FIG. 4 shows the cans (1), covered at the ends with the band or sheet (5) which is removed by pulling and tearing the tab (20), from the central band (5f), which is part of the band (5). The bases of the cans remain at the ends of each group or set.

FIG. 5 shows the cans (1) covered at their ends with the tape or sheet (6) which is removed by pulling and tearing the tab (20). The bases of the cans remain at the ends of each group or set.

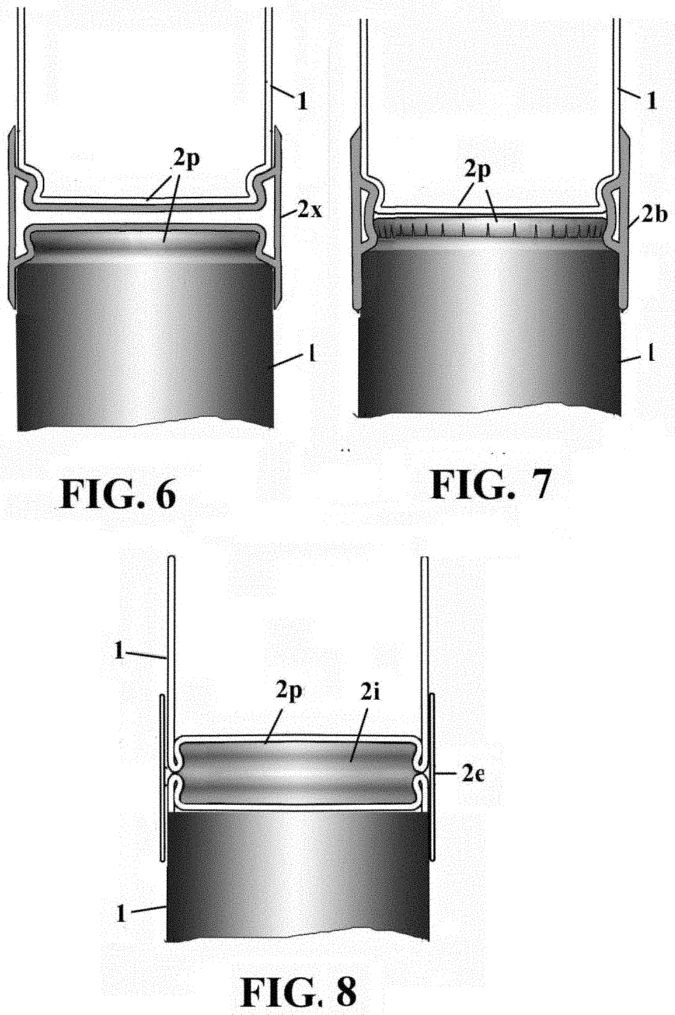

FIG. 6 shows two cans (1), covered at their ends by a flange or forming an internal flexible flange (2p), which are tongue-and-groove with a supplementary band (2x) made of biodegradable plastic, in channels where it is inserted under pressure.

FIG. 7 shows the can (1), covered at their flanged ends or forming an internal flexible flange (2p), which are tongue-and-groove with a circular supplemental band or biodegradable outer ring (2b), into which the canister end flanges carrying the nozzles and the means of opening are pressed.

FIG. 8 shows the cans (1), covered with a flange at their ends or forming an internal flexible flange (2p), which are tongue-and-groove with an internal biodegradable circular band or ring (2i), into which the flanges of the cans carrying the nozzles at their ends are pressed. Add the outer band (2e).

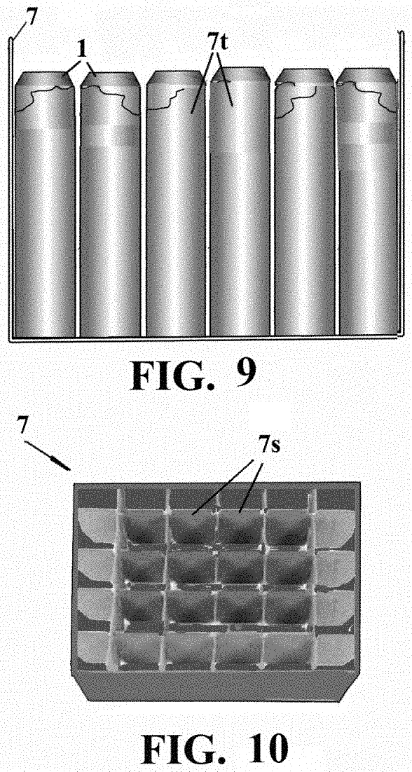

FIG. 9 shows the groups of cans (1) covered with a film or sheet of biodegradable material or plastic (7t) and arranged in the box of biodegradable material (7), which can be made of plastic foam that is equally biodegradable.

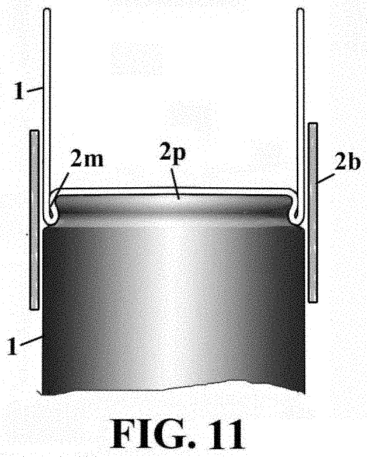

FIG. 10 shows the box of biodegradable material (7) with interior departments created by means of the partitions (7s) that allow its transport and storage without the use of contaminating material.

FIG. 11 shows the tongue and groove of the tabs (2p) with the (2m) of the cans (1), finishing with a ring band (2b).

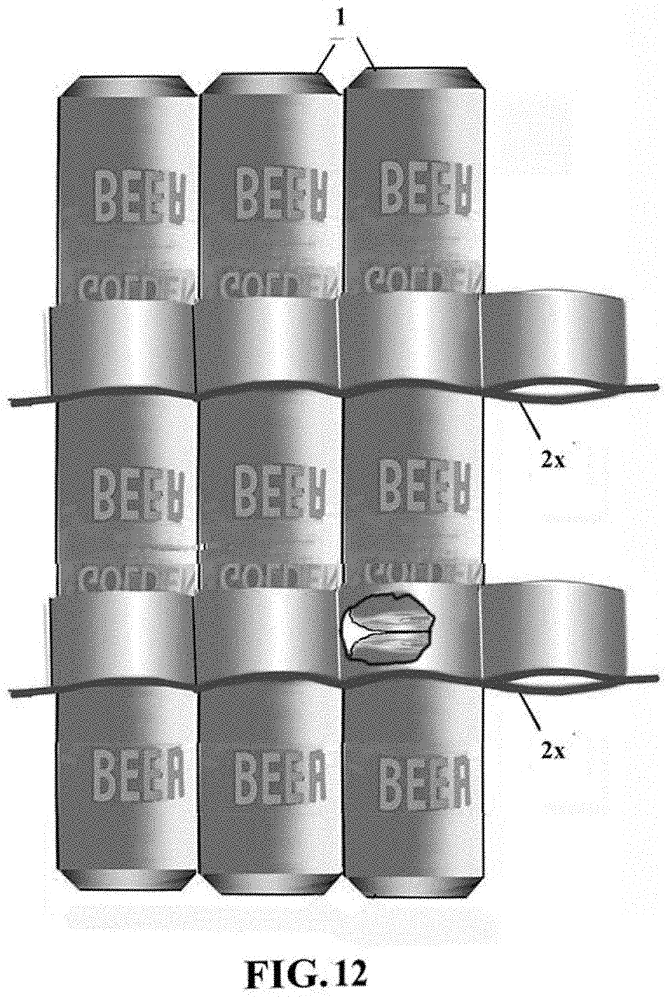

FIG. 12 shows groups of cans (1) attached lengthwise, whose adjoining and attached ends are covered with a seal and protective band of biodegradable plastic (2x), in the form of a perforated tray, which carries inside some annular channels where pairs of cans are tongue-and-groove at their ends.

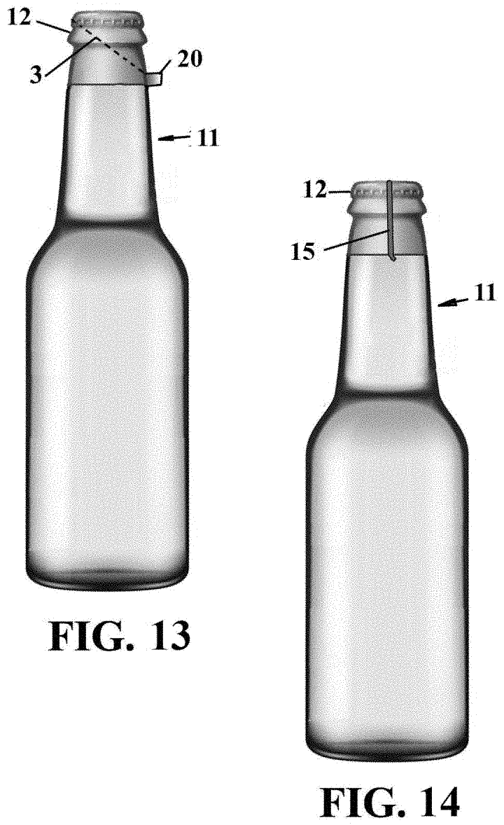

FIG. 13 shows a form of realization of the invention, it shows a bottle (11) with the end of the neck covered with the cap (12), which carries the line of weakening or tearing (3) when pulling the tab (20).

FIG. 14 shows a bottle (11) with the end of the neck covered with the cap (12), which carries the strip or tape of breakage or tearing (15).

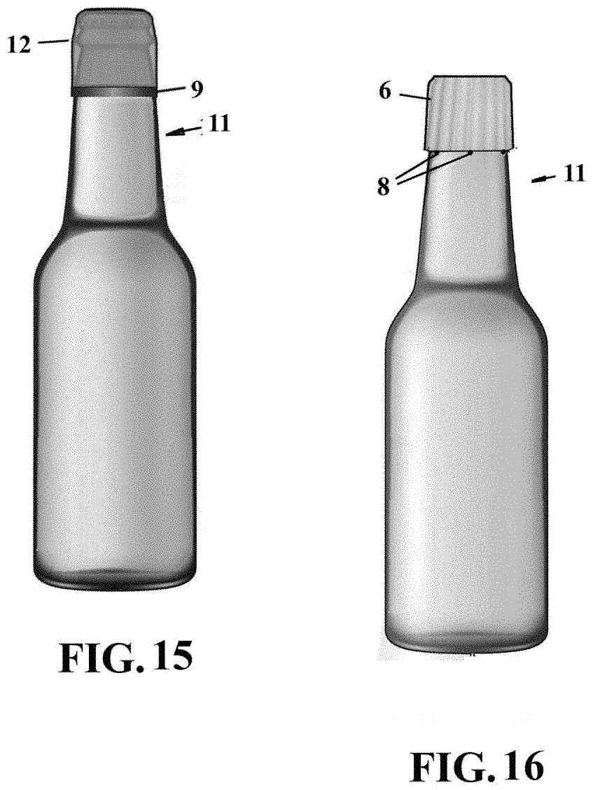

FIG. 15 shows a bottle (11) with the end of the neck covered with the cap (12), the edge of which (9) is thermally attached. Tear, strip or line systems of weakening and breaking, by pulling a tab, are not shown. The cap can be torn off by pulling it with a sharp element over the hollow areas.

FIG. 16 shows a bottle (11) with the end of the neck covered with the cap (6), which can be snapped on and has fixing points (8) of adhesive material on its periphery which tear and break when the cap is turned or pulled. Instead of the adhesive points, it can be fitted with skirts.

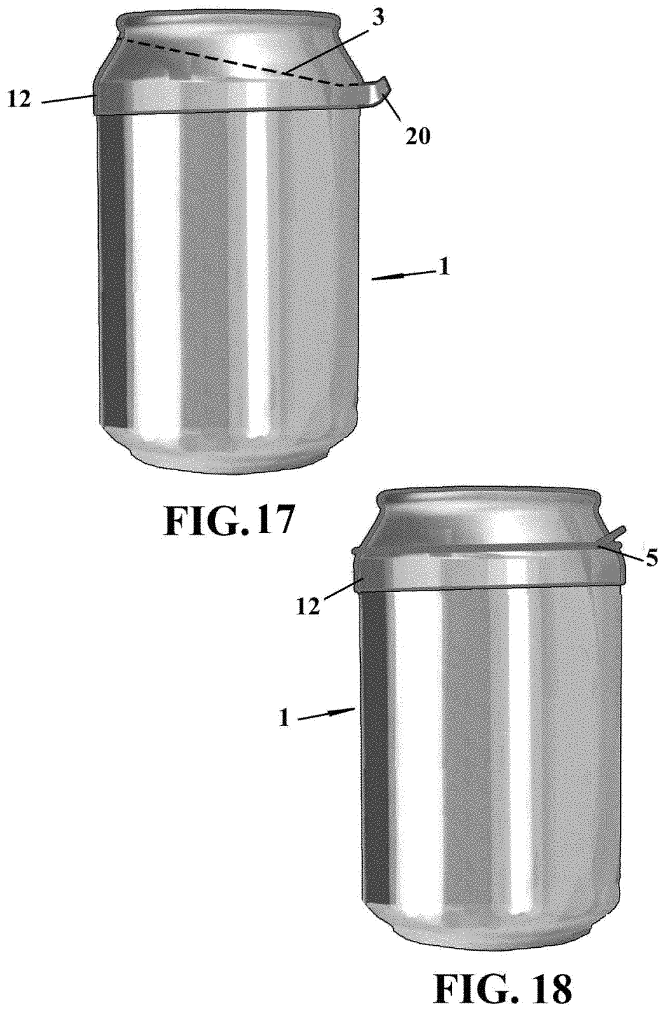

FIG. 17 shows a can (1) whose opening end carries the lid (12), which carries the weakening or tearing line (3) when the tab (20) is pulled.

FIG. 18 shows a can (1) whose opening end carries the cover (12), which carries the breaking or tearing strip or tape (5).

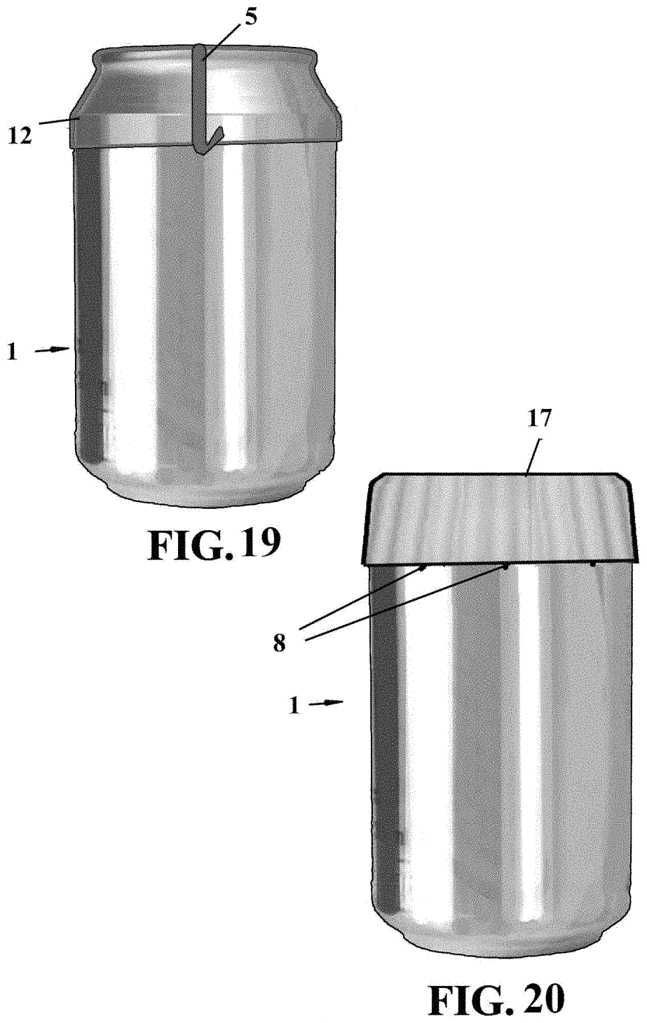

FIG. 19 shows a can (1) whose opening end carries the cover (12), which uses the breaking or tearing strip or tape (5).

FIG. 20 shows a can (1) whose opening end carries the lid (17), which is snapped on and has fixing points (8) of adhesive material on its periphery that tears and breaks when the lid is rotated or pulled. Instead of the fixing points, it can carry some skirts, which can be adhesive.

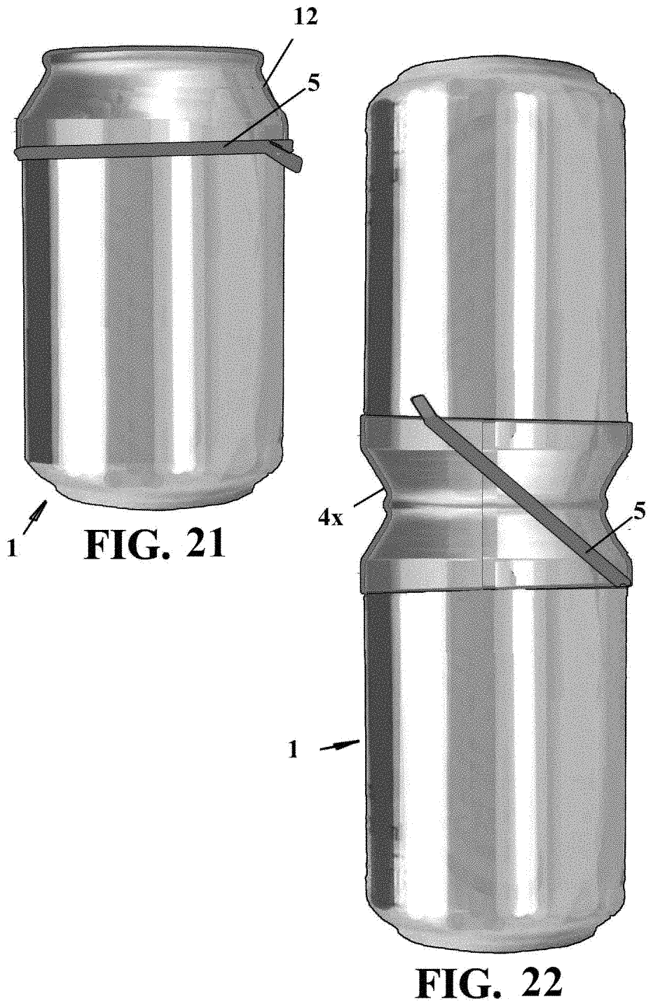

FIG. 21 shows a can (1) whose opening end carries the cover (12), which carries the tear or break tape or strip (5), next to the peripheral edge of the cover.

FIG. 22 shows the two cans (1). Cover their joint with the protective strip (4x) and carry the strip or tape of breakage or tearing (5). This can be replaced by a tear or weakening line as in FIG. 5.

1. Aseptic protective system against germs and dirt for beverage bottles and cans and system for joining beverage cans, characterized by:
a) The application of a protective cover to the mouth end of the beverage containers, whose protective elements are sheets or films, sleeves, caps, lids, caps or bands of biodegradable plastic materials or
b) The union by means of a longitudinal joint or tongue-and-groove joint of groups or rows of cans, the union using covers, sheets of tape, bands or a cover of biodegradable material or plastic that is added to them.

2. System according to claim 1, wherein the protective elements against germs and dirt carry strips or bands that tear, separate and leave the ends of the mouths of the bottles or cans free.

3. System according to claim 1, wherein the protective elements are caps or stoppers.

4. System according to claim 3, wherein the caps or stoppers are pressed on and fixed with a thin layer of adhesive.

5. System according to claim 3, wherein the caps or stoppers being fitted and fixed to the can or bottle by means of a light band or adhesive strip.

6. System according to claim 3, wherein the caps or stoppers are attached to the cans or bottles by means of fixing and breaking points, made of adhesive material.

7. System according to claim 3, wherein the caps or stoppers are fitted with optional adhesive skirts which extend the protection area.

8. System according to claim 1, wherein the cover is applied to pairs of cans or taps, covering their joint with the protective strip (2b) carrying a tape (5) or tear or weakening line.

9. System according to claim 1, wherein the biodegradable materials or plastics are made especially from starch and other vegetables.

10. System according to claim 1, wherein the protective elements are metallized biodegradable materials or plastics.

11. System according to claim 1, wherein the protective elements are loose except on the periphery of them in contact with the container, bottle or can, in this periphery carries a higher pressure on the container

12. System according to claim 1, wherein the protective elements are sleeves whose peripheral edge adheres to the bottle or can by thermally melting it by applying heat.

13. System according to claim 1, wherein the cans are attached and fastened by means of sheets of tape that surround the ends of every two attached cans.

14. System according to claim 1, wherein the cans are attached and fastened by means of sheets or strips of sealing tape around the ends of every two attached cans.

15. System according to claim 1, wherein the cans are attached and surrounded by means of sheets or bands, which carry in their central area a strip or tape that is torn for the independence of each can.

16. System according to claim 1, wherein the cans are attached and held in place by means of sealing covers that cover them completely.

17. System according to claim 1, wherein the ends of the attached cans (1), are flanged and form flexible internal tabs (2p) which are tongue-and-groove with an external biodegradable plastic supplemental band (2x), in which it is introduced under pressure in some channels of the same, multiple supplemental bands form a tray with perforations.

18. System according to claim 1, wherein the cans have their ends flanged or forming internal flexible tabs (2p), which are tongue-and-groove with a circular supplemental band or external biodegradable ring (2b), in which the ends of the cans carrying the nozzles and the means of opening are introduced under pressure.

19. System according to claim 1, wherein the cans have their ends flanged or forming internal flexible tabs (2p), which are tongue-and-groove with a circular supplemental band or biodegradable internal ring (2i), into which the ends of the cans are pressed.

20. System according to claim 1, wherein once the ends of the cans are tongue-and-groove, they are covered with the sheet, tape, band, cover or protective cover of biodegradable material.

21. System according to claim 1, wherein are use of biodegradable materials and plastics, using plant products, such as starch.

22. System according to claim 1, wherein biodegradable tapes, bands or films carry at their end a tear tab for their breakage and separation from the cans.
